(19) United States
(12) Patent Application Publication
(10) Pub. No.: US 2004/0062308 A1
(43) Pub. Date: Apr. 1, 2004

(54) System and method for accelerating video data processing

(76) Inventor: Gregg Mark Kamosa, Cambridge, MA (US)

Correspondence Address: RAUSCHENBACH PATENT LAW GROUP, LLC, P.O. BOX 387, BEDFORD, MA, 01730, US

(21) Appl. No.: 10/259,052

(22) Filed: Sep. 27, 2002

(51) Int. Cl. H04N 7/12

(52) U.S. Cl. 375/240.16

(57) ABSTRACT

A method and a system for accelerating the calculation of a motion estimation metric are described. During a single clock cycle, a first word and a second word of packed unsigned bytes are provided. Each byte in the first word represents a pixel in an image to be encoded and each byte in the second word represents a pixel in previously encoded image. Each byte in the second word of packed unsigned bytes is paired with one of the bytes in the first word of packed unsigned bytes. An error measure is calculated for each pair of bytes to compute a portion of the motion estimation metric for multiple pixels during a single clock cycle.

### BACKGROUND OF THE INVENTION

Real-time video applications are becoming more widely used throughout the world. Examples of real-time video applications include video teleconferencing, interactive multimedia, and digital television. These real-time video applications use digital video encoding to achieve data transfer rates that are necessary for transmitting video sequences over low-bandwidth communication channels. Digital video encoding techniques are computationally intensive. Improvements in the performance of semiconductor devices have made real-time video applications more cost effective.

Video sequences are temporal sequences of images in which each image is a description of a graphic picture. These descriptions can be stored as a set of brightness and color values of pixels or as a set of instructions for reproducing the picture. Prior art image processing systems include an encoder that encodes a first image in the video sequence and that transmits the encoded image to a decoder over a communication channel. The encoder and decoder each store the first image. The first image then serves as a reference image for encoding a temporally adjacent second image.

Much of the content of the graphic picture remains unchanged from one image to the next for temporally adjacent images. However, the content can appear in different places in these images. The second image is not fully encoded. The encoder determines a motion vector, having horizontal (x) and vertical (y) components that represent the displacement of content in the second image. The encoder sends this motion vector to the decoder. The decoder uses the motion vector to obtain the pixel data from the locally stored first image. Motion estimation is the process of determining this motion vector.

Each image of the video sequence in known motion estimation algorithms is sub-divided into blocks of pixels (typically a 16×16 block). One objective of motion estimation algorithms is to find a region (referred to as a predictor block) in the reference image that most closely matches that source block for each block that is to be encoded. This search for the best match can be limited to a specified search area within the reference image. This search process is commonly referred to as block matching.

Another objective of motion estimation algorithms is to produce a motion vector for each source block. The motion vector specifies an offset at which the best matching predictor block for that source block can be found in the search area. The predictor block that best matches the corresponding source block is the one that minimizes an error measure. Examples of error measures are the sum of absolute differences (SAD) and the sum of squared errors (SSE). Calculating the error measure between the predictor and source blocks is a computationally intensive portion of the motion estimation algorithm. Therefore, any improvement that increases the speed of these calculations can accelerate the video encoding process in general.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a video processor according to the present invention.

FIG. 2 is a block diagram of an embodiment of a designer-defined computational unit (DDCU) of the processor illustrated in FIG. 1.

FIG. 3 is a diagram of an example of a block of predictor pixels that is stored in a data memory according to the present invention.

FIG. 4A is a block diagram of an embodiment of the buffer memory of the Designer-Designed Computational Unit (DDCU) shown in FIG. 2.

FIG. 4B is a block diagram of an embodiment of the calculator of the Designer-Designed Computational Unit (DDCU) shown in FIG. 2.

FIG. 5 is a flow diagram of an embodiment of a process performed by the Designer-Designed Computational Unit (DDCU).

FIG. 6 is a block diagram of another embodiment of the calculator of the Designer-Designed Computational Unit (DDCU) illustrated in FIG. 2.

### DETAILED DESCRIPTION

The present invention relates to systems and methods that perform motion estimation for video and multimedia applications. In one embodiment, the system and methods of the present invention accelerate video processing by accelerating the video encoding process by reducing the time that it takes to calculate the error measure between the predictor and source blocks in motion estimation algorithms.

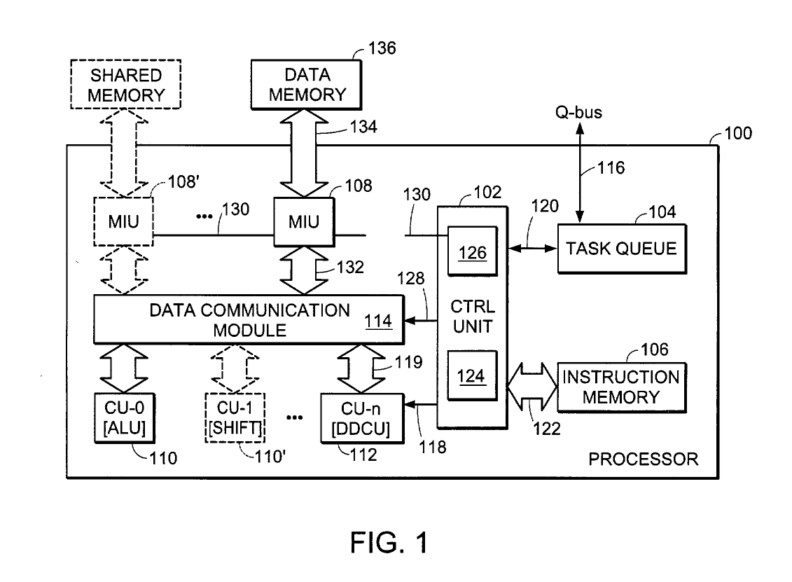

FIG. 1 is a block diagram of an embodiment of a video processor 100 according to the present invention. The video processor 100 is also referred to as a video engine. The video processor 100 is designed to perform video encoding in accordance with the principles of the invention.

The video processor 100 can be incorporated in a single or a multi-processor system, such as an image processing system, a computer system, or a video encoder. In one embodiment, the processor 100 is configurable. In this embodiment, the designer can use software tools to add custom data paths, logic and computational units that implement the specific functionality of a target application (e.g., video conferencing).

The video processor 100 includes a collection of resources that are programmable to perform a set of operations in a given sequence. In one embodiment, the processor 100 is a special purpose microprocessor, such as a digital signal processor (DSP). Such processors are programmable with their own native instruction code, and are designed to execute arithmetic operations more rapidly and efficiently than general-purpose microprocessors. Such processors implement instruction-level parallelism and thus operate in an architecture that supports multiple operations in a single clock cycle. In one embodiment, the processor implements a Very Long Instruction Word (VLIW).

In one embodiment of the invention, the designer can define custom logic and computational units, such as a collection of parallel data path elements. For example, in this embodiment, the designer can define ALUs (Arithmetic Logic Units), shifters, and multiply and accumulates (MACs), in the processor 100. In one embodiment, the processor 100 includes at least one such Designer-Designed Computational Unit (DDCU) that is designed to accelerate motion estimation in a video encoding process as described herein.

The custom logic and computational units can significantly improve the performance of the processor 100 by creating different combinations of processing resources that are specifically designed for particular applications. Similarly, the custom data paths optimize the performance of the computational unit for each instruction.

The video processor 100 includes computational units that perform the processing of an application. In the embodiment shown, the video processor 100 includes a control (CTRL) unit 102, a task queue 104, an instruction memory 106, at least one memory interface unit (MIU) 108, at least one computational unit 110, at least one designer-defined computational unit (DDCU) 112, and a data communication module 114. A processor 100 according to the present invention includes a DDCU 112 that is designed to accelerate the performance of motion estimation.

The control unit 102 is electrically connected to the task queue 104 by a task controller bus 120. The control unit 102 is electrically connected to the instruction memory 106 by an instruction memory bus 122. The control unit 102 includes an instruction decoder 124 that decompresses and decodes instructions received from the instruction memory 106 for execution by the processor 100. The decoder 124 determines the memory address of the instruction to be executed. The control unit 102 also includes a branch control unit 126 that controls the order of execution of the instructions.

The task queue 104 includes a stack that stores tasks. The task queue 104 communicates with a computer system (not shown) through a task queue bus (Q-bus) 116. The Q-bus 116 communicates task and control information between the processor 100 and other processors, if any, in the computer system. The processor 100 performs the tasks in the stack in a defined order, such as first-in, first-out (FIFO).

The instruction memory 106 stores instructions. The instruction memory 106 can be shared memory (i.e., shared with other processors) or can be private memory (i.e., reserved for use exclusively by the processor 100). The instruction memory 106 stores instructions that are chosen to execute on the at least one computational units 110 and the at least one DDCU 112.

An MIU control bus 130 electrically connects the control unit 102 to the at least one MIU 108. A data bus 132 electrically connects the at least one MIU 108 to the data communication module 114. A data memory port bus 134 electrically connects a memory 136 to the at least one MIU 108. The memory 136 can be shared memory or can be private memory. In one embodiment, the pixels are stored in contiguous bytes of memory. Each pixel, for example, may be represented by one byte (or 8 bits).

The pixel bytes are organized into words. The word sizes can be 16 and 32 bits (i.e., 2 and 4 bytes). The word sizes can also be 64, 128 and 256 bits (i.e., 8, 16, and 32 bytes). The following description is based on 32-bit word sizes. However, the principles of the invention can apply to any of the word sizes.

In one embodiment, the data memory 136 stores pixel data that is associated with the image that is currently being encoded (source image), with the image that was previously encoded (reference image), and the predictor pixel data. The MIU 108 receives instructions from the control unit 102 to retrieve words of predictor pixel data and source pixel data from the data memory 136. The MIU 108 also receives instructions to send the words to the at least one computational unit 110 and the at least one DDCU 112.

In one embodiment, the MIU 108 reads pixel data from the data memory 136 on word boundaries only. In this embodiment, a memory read cannot cross over a word boundary between contiguous words. For example, a four-byte read cannot take one byte from a first word and three bytes from a second word, or two bytes from a first word and two bytes from a second word. That is, each read retrieves all four bytes of one word.

Each word by the MIU 108 has a packed data format. By packed data format, we mean that the bits of a word, which normally would together represent one value, are instead grouped into smaller, fixed-sized data elements that each represents a value. Consequently, a packed data format in which the data elements are each 8 bits in size means that a 32-bit word represents four separate values. Thus, reading a 32-bit word of pixel data from the data memory 136 retrieves four bytes associated with four pixels.

The control unit 102 is connected to the at least one computational unit 110 and the at least one DDCU 112 though a control bus 118. The data communication module 114 is connected to the at least one computational unit 110 and the at least one DDCU 112 though a data bus 119. Multiple read or write memory ports can be attached to each of the at least one computational unit 110 and to each of the at least one DDCU 112.

In the processor of the present invention, designers can define the number and type of operations that can be executed for each instruction of each of the at least one computational unit 110 and each of the at least one DDCU 112. For example, to implement ALU intensive applications, a designer can provide the processor 100 with three ALUs, one shifter, and one MAC. To implement MAC-intensive and balanced applications, a designer can provide the processor 100 with two ALUs, two shifters, and two MACs.

In one embodiment, the DDCU 112 is a designer-designed computational unit that is designed to support video data applications that perform video encoding in general and motion estimation in particular. More specifically, the DDCU 112 is tailored to accelerate the computationally intensive portion of the motion estimation process that involves calculating the error measure between a candidate predictor block and a source block of the current image to be encoded.

In one embodiment, the DDCU 112 is a multiple SAD calculation unit that calculates the sum of absolute value of differences for multiple pixels in a single processor clock cycle. In another embodiment, the DDCU 112 is a sum of squared error (SSE) calculation unit that calculates the squared error for multiple pixels in a single processor clock cycle.

In another embodiment, the processor 100 includes a first DDCU for calculating SAD and a second DDCU for calculating the sum of the squared error. The processor 100 implements an instruction that selects which of the two DDCUs to use during video encoding. In yet another embodiment, a single DDCU calculates both SAD and sum of the squared error. The processor 100 implements an instruction that selects between the two calculation types. In other embodiments, the processor 100 includes a DDCU that implements other types of image processing tasks, such as image recognition and target acquisition.

A control bus 128 connects the data communication module 114 to the control unit 102. Data is routed from the memory interface unit 108 and the computational units 110, 112 through the data communication module 114. The control unit 102 transmits instructions and task control information to the data communication module 114. The branch control unit 126 receives control information from the data communication module 114 that can cause the control unit 102 to change the schedule of task execution.

In one embodiment, the data communication module 114 is a register-router module that manages the routing of data from register-to-register. The data communication module 114 routes data from result or data memory registers (not shown) to input registers (not shown) of the computational units 110, 112. The data communication module 114 also routes data from the result registers of the computational units 110, 112 to the result or data memory registers.

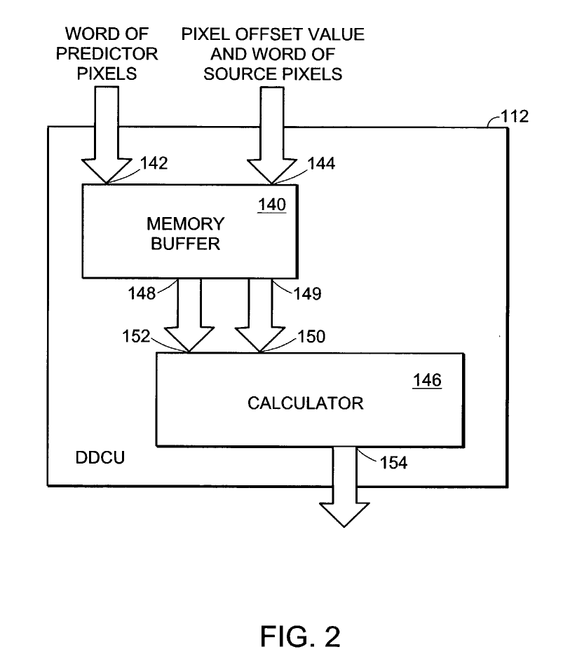

FIG. 2 is a block diagram of an embodiment of a designer-defined computational unit (DDCU) 112 of the processor illustrated in FIG. 1. The DDCU 112 includes a memory buffer 140 that is in communication with a calculator 146. The memory buffer 140 includes a first input 142, a second input 144, a first output 148, and a second output 149. The first 142 and second inputs 144 are electrically connected to the data communication module 114 by the data bus 119 (FIG. 1). In one embodiment, the data communication module 114 sends pixel data to the memory buffer 140 through the data bus 119. For example, each word of pixel data received at the first 142 and second inputs 144 can have four packed unsigned bytes.

The DDCU 112 also includes a calculator 146. The calculator 146 includes a first input 150 that is electrically connected to the second output 149 of the memory buffer 140. The calculator 146 also includes a second input 152 that is electrically connected to the first output 148 of the memory buffer 140.

In one embodiment, the memory buffer 140 stores four bytes of useful predictor pixel data and four bytes of source pixels for the calculator 146 as described herein. The second input 144 receives a pixel offset value from the data communication module 114. The pixel offset value is based on the position of the predictor block within the search area of the reference image.

The pixel offset is calculated from the byte address of the raw pixels. For example, as different areas of pixels are searched, the search may start at a byte offset of [100] one time, and then [101] the next. For a byte offset of [100], we get the starting word address by dividing by four (4 bytes/word), which is equal to twenty-five, with a remainder of zero. Thus, for a byte offset of [100], the offset is equal to zero and the byte starting address coincides with a word boundary. For a byte offset of [101], the word address will be twenty-five, with a remainder of one, therefore, three of the four desired pixels lie in word twenty-five, and one in word twenty-six. Thus, for a byte offset of [101], the offset value is equal to one.

The first output 148 passes four bytes of predictor pixel data to the second input 152 of the calculator 146. The four bytes are packed unsigned integer values representing four predictor pixels. The second output 149 passes four bytes of source pixel data to the first input 150 of the calculator 146. The four bytes are packed unsigned integer values representing four source pixels.

In one embodiment, the calculator 146 includes circuitry that compares received predictor pixels with the source pixels and calculates an overall value that quantifies the error measure between the two blocks (i.e., the predictor block and the source block). The calculator 146 also includes an output 154 for sending the overall value (or in some embodiments sub-totals) to the data communication module 114 (FIG. 1). The memory buffer 140 and the calculator 146 of the DDCU 112 are implemented in hardware that enables the DDCU 112 to perform the comparison for multiple pixels during each clock cycle of the processor 100 of FIG. 1.

In operation, the MIU 108 (FIG. 1) retrieves predictor pixel data and source pixel data from the data memory 136 (FIG. 1). If the MIU 108 retrieves predictor pixel data only on word boundaries then one or more bytes in the word can include pixel data that are not valid for use in the comparison with source pixels. This occurs if the horizontal pixel offset used for searching a best match is not a multiple of four (for words that are four bytes in size).

The horizontal pixel offset is the horizontal component of the displacement of the candidate predictor block from its original position in the previously encoded image. Thus, for example, if the horizontal pixel offset is +3, then retrieving a 4-byte word of predictor pixels retrieves one byte of useful predictor pixel data that can be compared with source pixel data and three bytes of extraneous pixel data. In this example, the memory buffer 140 buffers the one useful byte of predictor pixels and aligns that byte with three bytes of predictor pixels from a subsequently retrieved word to form a four-byte word of useful predictor pixels that is output to the calculator 146.

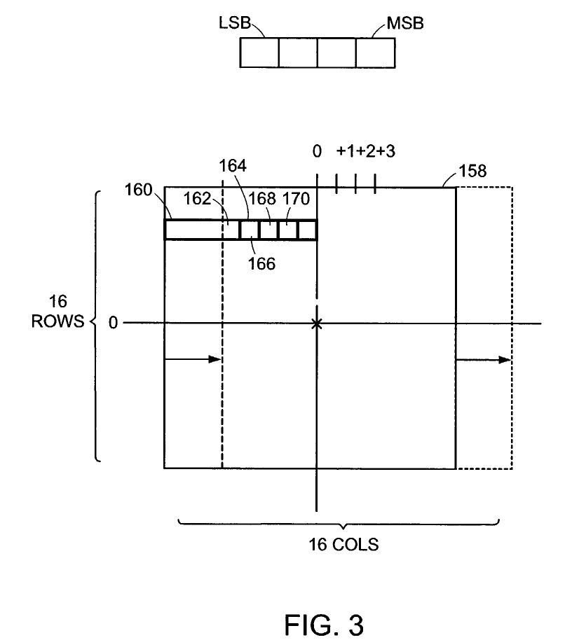

FIG. 3 is a diagram of an example of a block of predictor pixels that is stored in a data memory according to the present invention. The block of predictor pixels shown in FIG. 3 is a 16×16 block 158 of predictor pixels. The predictor pixels are stored in the data memory 136 (FIG. 1) as four-byte words. The words 160 and 164 are examples of words having four bytes of pixels. The leftmost byte in each word is the least significant byte, and the rightmost byte is the most significant byte. The block 158 is shown in its original position in the previously encoded image. An “X” denotes the origin (0, 0) of the block 158. For a horizontal pixel offset of +3, the block 158 shifts by three pixels to the right, as indicated by the arrows and dashed lines.

The result of the shift is that only one byte 162 of the four bytes in word 160 remains within the shifted predictor block 158, whereas all four bytes of the word 164 remain within the shifted predictor block 158. Thus, upon receiving the word 160, the DDCU 112 receives one byte of useful predictor pixels and three bytes of extraneous pixel data. As described in more detail below, the memory buffer 140 (FIG. 2) buffers and combines the one useful byte 162 with three bytes 166, 168, 170 of the word 164. The memory buffer 140 then generates a word of packed bytes 162, 166, 168, and 170 representing four useful predictor pixels.

Referring to FIG. 2, if the horizontal pixel offset is a multiple of four, no byte alignment is needed, and the memory buffer 140 operates to pass the word of predictor pixels to the calculator 146 without changing the word. Referring to FIG. 1, if the MIU 108 retrieves pixel data on byte boundaries, and thus accommodates horizontal pixel offsets that are not a multiple of four, the byte alignment operation of the memory buffer 140 can be disabled so that the word of packed predictor pixels passes directly to the calculator 146.

Referring to FIG. 3, the MIU 108 is able to retrieve bytes 162, 166, 168 and 170 as one word although these bytes extend into two contiguous words. In one embodiment, this bypass is accomplished by setting to zero the pixel offset value that the memory buffer 140 receives from the calculator 146 (FIG. 2).

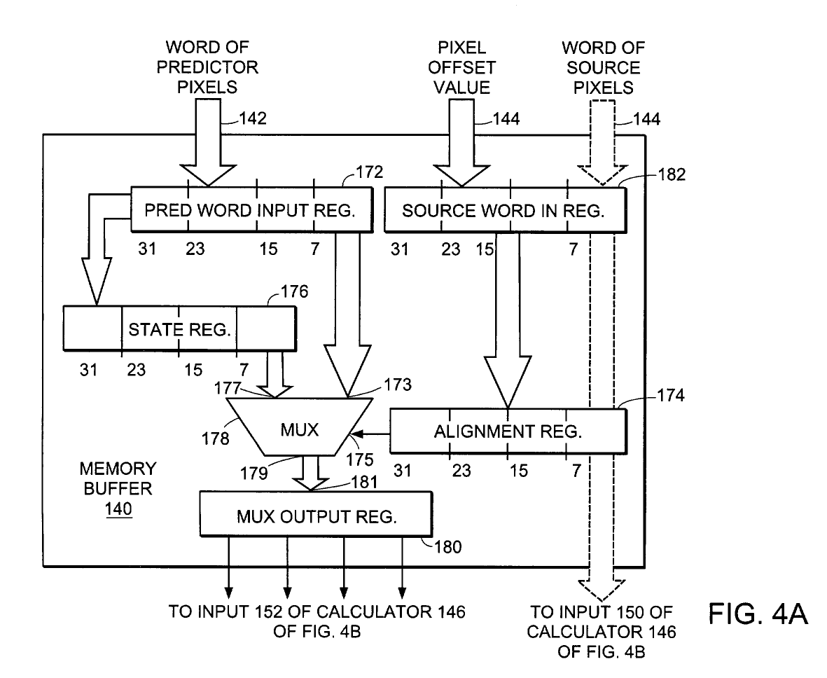

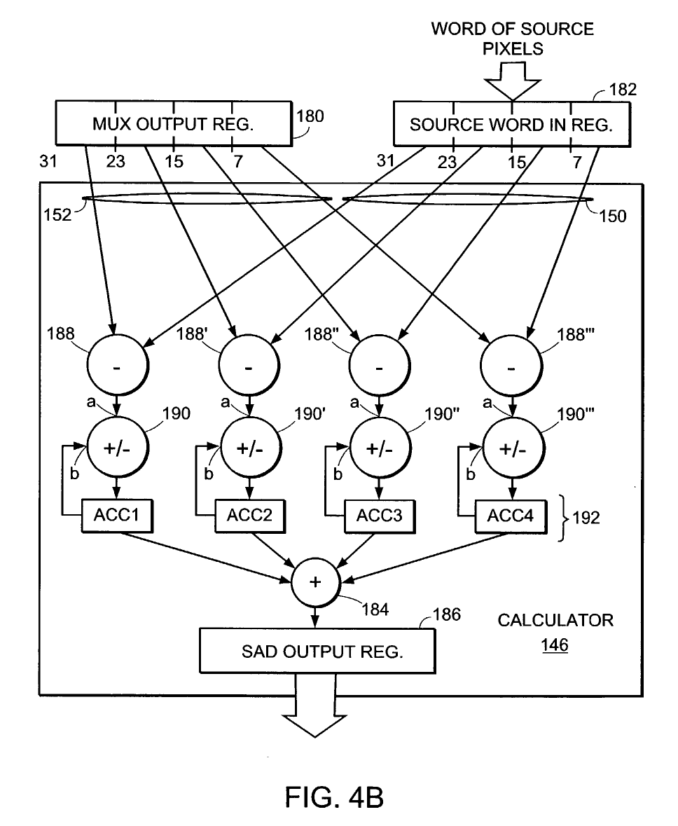

FIG. 4A is a block diagram of an embodiment of the buffer memory 140 of the Designer-Designed Computational Unit (DDCU) 112 shown in FIG. 2. In brief overview, for each processor clock cycle the memory buffer 140 receives four bytes of predictor pixels and four bytes of source pixels from the data communication module 114 (FIG. 1) and provides four valid bytes of predictor pixels and four bytes of source pixels to the calculator 146.

The memory buffer 140 includes a predictor word input register 172, an alignment register 174, a state register 176, a multiplexer (mux) 178, a mux output register 180, and a source word input register 182. The predictor word input register 172 and the source word input register 182 are in communication with the data communication module 114 of FIG. 1. The alignment register 174 is in communication with the source word input register 182. The state register 176 is in electrical communication with the predictor word input register 172.

The mux 178 includes three inputs 173, 175, 177 for receiving input data from the predictor word input register 172, the alignment register 174, and the state register 176, respectively. The mux 178 also includes an output 179. The mux output register 180 includes an input 181 that is in electrical communication with the output 179 of the mux 178.

The source word input register 182 receives a pixel offset value on input 144 from the data communication module 114 during initialization of the DDCU 112 (FIG. 2). The processor 100 (FIG. 1) typically calculates pixel offset value using an algorithm. The calculated pixel offset value is then passed to a source register (not shown) in the DDCU 112 as an instruction before raw pixel data is passed to the DDCU 112 for computation. In one embodiment, the calculated pixel offset value is passed to a source register with a separate initialization operation. The source word input register 182 transfers the pixel offset value to the alignment register 174.

In operation, during a first clock cycle, the predictor word input register 172 receives a first word of predictor pixels on input 142. The predictor word input register 172 passes the first word of predictor pixels to the state register 176. In a second clock cycle, the predictor word input register 172 receives a second word of predictor pixels. The mux 178 receives the first word of predictor pixels from the state register 176 on input 177, the second word of predictor pixels from the predictor word input register 172 on input 173, and the pixel offset value from the alignment register 174 on input 175.

The alignment register 174 controls the mux 178 to ensure that four bytes of valid predictor pixel data are available for comparison with the source pixel data in the current clock cycle. The value in the alignment register 174 determines the output of the mux 178 by indicating which bytes of the state register 176 and which bytes of the predictor word input register 172 are placed in the mux output register 180. Table 1 illustrates an example of the definition of the output produced by the mux 178 for each possible two-bit value that can be stored in the alignment register 174.

TABLE 1

| Alignment | |
|---|---|
| register | |
| Value | Output (Most Significant Byte to Least Significant Byte) |
| 0 | (state_register[31:24], state_register[23:16], state_{—} |
| | register[15:8], state_register[7:0]) |
| 1 | Predictor_word_input_register[7:0], state_register[31:24], |
| | state_register[23:16], state_register[15:8]) |
| 2 | (predictor_word_input_register[15:8], |
| | predictor_word_input_register[7:0], state_register[31:24], |
| | state_register[23:16]) |
| 3 | (predictor_word_input_register[23:16], |
| | predictor_word_input_register[15:8], |
| | predictor_word_input_register[7:0], state_register[31:24]) |

Based on the input data, the mux 178 produces four bytes of packed unsigned data representing four predictor pixel values. The word of predictor pixels passes to the mux output register 180.

Also in the second cycle, the source word input register 182 receives a word of source pixels on input 144 (shown in phantom). The word of source pixels does not require byte alignment, because the alignment is ensured by the application performing the encoding. Furthermore, in the second cycle, the word of predictor pixels passes from the mux output register 180 to the input 152 of the calculator 146 (FIG. 4B), and the word of source pixels passes from the source word input register 182 to the input 150 of the calculator 146 (FIG. 4B).

FIG. 4B is a block diagram of an embodiment of the calculator 146 of the Designer-Designed Computational Unit (DDCU) 112 shown in FIG. 2. The calculator 146 is in electrical communication with the memory buffer 140 of FIG. 4A. In brief overview, the calculator 146 receives four bytes of predictor pixels and four bytes of source pixels from the memory buffer 140 and simultaneously calculates a sum of absolute differences (SAD) between the four predictor pixels and four source pixels within a single clock cycle.

The calculator 146 includes a summing circuit 184 and a SAD output register 186, a plurality of subtraction units 188, 188′, 188″, 188′″ (generally, subtraction unit 188), a plurality of add-subtract units 190, 190′, 190″, 190′″ (generally, add-subtract unit 190) and a plurality of accumulators 192 (labeled ACC1, ACC2, ACC3, and ACC4). For each pair of bytes being compared to each other, there is one subtraction unit 188, add-subtract unit 190 and accumulator 192.

A pair of bytes refers to a byte of a predictor word that is stored in the mux output register 180 and its respective byte of a source word that is stored in the source word input register 182. An example of a pair of bytes is the most significant byte (bits 24 to 31) in the mux output register 180 and the most significant byte (bits 24 to 31) in the source word input register 182.

Each subtraction unit 188 includes two inputs: a first input is in communication with one byte of the mux output register 180 and a second input is in communication with one byte of the source word input register 182. For example, one input of the subtraction unit 188′″ is in electrical communication with the least significant byte (bits 0-7) of the mux output register 180 and the second input is in communication with the least significant byte (bits 0-7) of the source word input register 182. Each subtraction unit 188 also includes one output that is in electrical communication with a respective one of the plurality of add-subtract units 190.

Each add-subtract unit 190 is in electrical communication with a respective one of the plurality of subtraction units 188 and a respective one of the plurality of accumulators 192. Each add-subtract unit 190 includes two inputs (labeled “a” and “b”) and an output. The input “a” is electrically connected to the output of the respective subtraction unit 188, and the input “b” is electrically connected to an output of the respective accumulator 192. The output of the add-subtract unit 190 is electrically connected to an input of the respective accumulator 192.

In one embodiment, each accumulator 192 is a 14-bit register for storing a 14-bit unsigned value. Each accumulator 192 includes one input that is electrically connected to the output of the respective add-subtract unit 190 and two outputs. One of the outputs is electrically connected to the input “b” of the respective add-subtract unit 190 and the other output is electrically connected to the summing circuit 184.

The summing circuit 184 includes an input for each accumulator 192 and an output that is electrically connected to the SAD output register 186. In one embodiment, the summing circuit 184 and the SAD output register 186 are 16-bit registers.

During a first clock cycle, the memory buffer 140 (FIG. 4A) receives a word of predictor pixels and a word of source pixels from the data communication module (FIG. 1). The memory buffer 140 produces a word of valid predictor pixels and places this word in the mux output register 180, as described in FIG. 4A. The source word input register 182 stores the word of source pixels.

During a second clock cycle, the calculator 146 receives the word of valid predictor pixels from the mux output register 180 on input 152 and the word of source pixels from the source word input register on input 150 to form a valid four bytes of data. Each subtraction unit 188 receives one unsigned byte of predictor pixel data from the mux output register 180 and one unsigned byte of source pixel data from the source word input register 182.

In one embodiment, each subtraction unit 188 subtracts the source pixel value from the predictor pixel value and produces a nine-bit signed value having the range of values of −255 to 255. The subtraction result produced by subtraction unit 188 passes to the input “a” of the respective add-subtract unit 190.

Each add-subtract unit 190 combines the subtraction result received on the input “a” with the current value in the respective accumulator 192. If the most significant bit of the input “a” is a “1” then the add-subtract unit 190 performs a subtraction (b−a). If the most significant bit of the input “a” is a “0” then the add-subtract unit 190 performs an addition (b+a). The selection of either the addition or subtraction operation based on the value of the most significant bit accomplishes the absolute value operation.

The result of the addition or subtraction operation is stored in the respective accumulator 192. Each accumulator 192 stores a 14-bit unsigned value. In one embodiment, the various hardware components of the calculator 146 (i.e., subtraction units 188, add-subtract units 190, and accumulators 192) propagate the SAD calculations in less than 10 nsec, thereby allowing the calculator 146 to perform multiple SAD calculations within a single cycle. Thus, during the second clock cycle, the calculator 146 simultaneously calculates the following equations:

ACC1+=|a₄ᵢ−b₄ᵢ|;

ACC2+=|a₄ᵢ₊₁−b₄ᵢ₊₁|;

ACC3+=|a₄ᵢ₊₂−b₄₊₂|;

and

ACC4+=|a₄ᵢ₊₃−b₄ᵢ₊₃|;

where “ACC” identifies the accumulator 192 in which the results of the respective calculation is stored, “i” is an integer ranging from 0 to 3, “a” is a byte of predictor pixels, and “b” is a byte of source pixels.

The calculator 146 also calculates these equations for each subsequent clock cycle, until the DDCU 112 has compared a full block of predictor pixels with a full block of source pixels. After the full predictor pixel block is complete, during a subsequent clock cycle, the summing circuitry 184 adds together the values stored in the accumulators 192 producing a 16-bit unsigned value, and stores the total in the SAD output register 186.

An instruction set (also referred to as a set of micro-operations or Mops) is associated with the DDCU 112 of FIG. 2. By issuing these particular Mops, the various elements of the circuitry in the memory buffer 140 and in the calculator 146 of the DDCU 112 are instructed to perform certain tasks, which, when properly programmed, accelerate the process of motion estimation. The Mops include, for example:

ClrAcc( )—This Mop clears the accumulators 192 (i.e., all accumulators 192 are zeroed). This Mop is called prior to initiating a SAD calculation on a block of pixel data.

Init(In1, In2)—This Mop loads the value stored in the source word input register 182 into the alignment register 174 and the value stored in the predictor word input register 172 into the state register 176. The value stored the source word input register is the pixel offset value for the predictor block. This pixel offset value is “ANDed” with the value of 0×3 before being stored in the alignment register 174. For example, if the pixel offset value is 0×6, after this value is ANDed with 0×3, the value stored in the alignment register 174 is 0×2 (0110∩0011=010). Pseudo-code illustrating operation of this Mop is:

alignment register [1:0=In1[1:0

state_register[31:0=In2[31:0

This Mop is called prior to initiating a SAD calculation on each row in the block of pixels.

ComputeSAD(In1, In2)—This Mop provides the DDCU 112 with a new word of source pixels and a new word of predictor pixels. The new word of source pixels passes to the source word input register 182 and the new word of predictor pixels passes to the predictor word input register 172. As described above, the mux 178 constructs an output from the predictor word input register 172 and the state register 176 based on the value in the alignment register 174. This result passes to the mux output register 180. The calculator 146 then performs the SAD operation, as described herein, using the values stored in the mux output register 180 and in the source word input register 182.

At the completion of this Mop, the contents of the predictor word input register 172 are stored in the state register 176. The next execution of this Mop has four valid bytes of predictor pixel data, including those bytes in the predictor word input register 172 that are not used during the current SAD calculation. Such unused bytes will be used during the next execution of this Mop because the pixel offset value in the alignment register 174 is unchanged.

Since the pixel offset value is unchanged, the mux 178 selects from the same byte positions in the state register 176 as it did during the previous SAD calculation. Those same byte positions now contain the contents of the previously unused bytes of the predictor word input register 172 as a result of the transfer. Pseudo-code illustrating the results is as follows:

State_register[31:0=Predictor_word_input_register[31:0

Acc1+=Abs(mux_output_register[31:24]−source_word_input_register[31:24])

Acc2+=Abs(mux_output_register[23:16]−source_word_input_register[23:16])

Acc3+=Abs(mux_output_register[15:8]−source_word_input_register[15:8])

Acc4+=Abs(mux_output_register[7:0]−source_word_input_register[7:0])

RetAcco—This Mop sums the four accumulators 192 to form the output SAD for the current block.

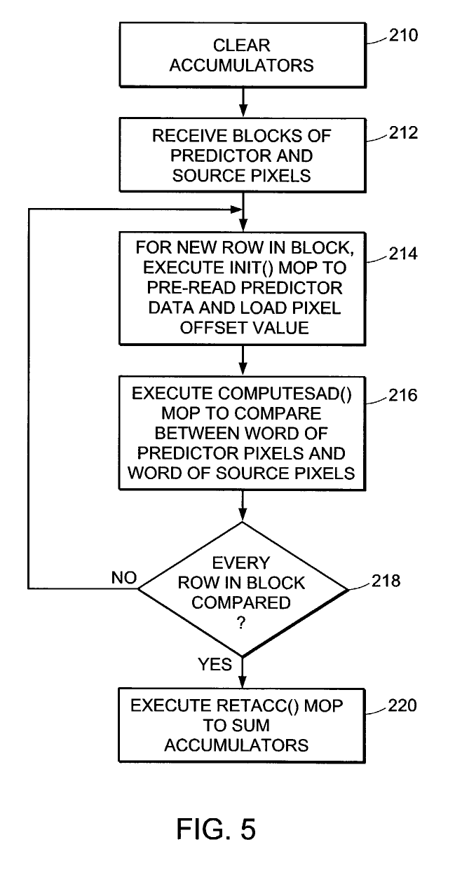

FIG. 5 is a flow diagram of an embodiment of a process performed by the Designer-Designed Computational Unit (DDCU) of the present invention. Specifically, FIG. 5 illustrates an embodiment of a process for accelerating motion estimation in a system featuring the Mops described herein. In brief overview, the DDCU 112 of FIG. 1 calculates the sum of absolute differences for a motion estimation process that uses block matching within a search area (e.g., ±8 pixels) determined by the application controlling the video encoding. For each video block, the DDCU 112 implements the following equation:

$$SAD = {\sum }_{i} {\sum }_{j} \vert {a}_{i j} - {b}_{i j} \vert$$

where i represents the row and j the column.

In step 210, the processor 100 of FIG. 1 executes a ClrAcc( ) instruction to clear or zero the accumulators 192 in the DDCU 112. The MIU 108 (FIG. 1) obtains (step 212) a block of predictor pixels within the search area and a block of source pixels from the data memory 134. Prior to the start of a SAD calculation for each row of the predictor block, the processor 100 executes (step 214) an inito instruction. As a result, the MIU 108 sends the first word that contains predictor pixel data that is to be used in the SAD calculation to the predictor word input register 172 in the memory buffer 140 (FIG. 4A) of the DDCU 112. The first word then passes from the predictor word input register 172 to the state register 176. This read obtains one to four bytes of useful pixel data, depending on the pixel offset used to position the predictor block in the search area.

The inito instruction also causes the pixel offset value stored in the source word input register 182 (FIG. 4A) to be loaded into the alignment register 174 (FIG. 4A), as described above. A pointer to the next word of predictor pixels is passed back to the application controlling the video encoding.

In step 216, the processor 100 executes the ComputeSAD instruction, which causes the next word of predictor pixels to be loaded into the predictor word input register 172 (FIG. 4A). The ComputeSAD instruction also causes a corresponding word of source pixels to be loaded into the source word input register 182 (FIG. 4A). As a result, the mux 178 produces a word with four bytes of valid pixel data, which is stored in the mux output register 180. Also, within a single clock cycle, the, subtraction units 188, the add-subtract units 190, and the accumulators 192 produce absolute differences for each pair of pixels being compared.

In step 218, the processor 100 determines if every row in the predictor and sources blocks have been compared. If not, the process returns to step 214 and repeats with the next row of predictor pixels in the block.

After comparisons between the predictor block and the source block have completed for every row in the blocks, the processor 100 executes (step 220) the RetAcc( ) micro-operation, which sums the accumulators 192 (FIG. 4B) and stores the sum in the SAD output register 186 (FIG. 4B). This sum represents the sum of absolute differences for the current predictor block.

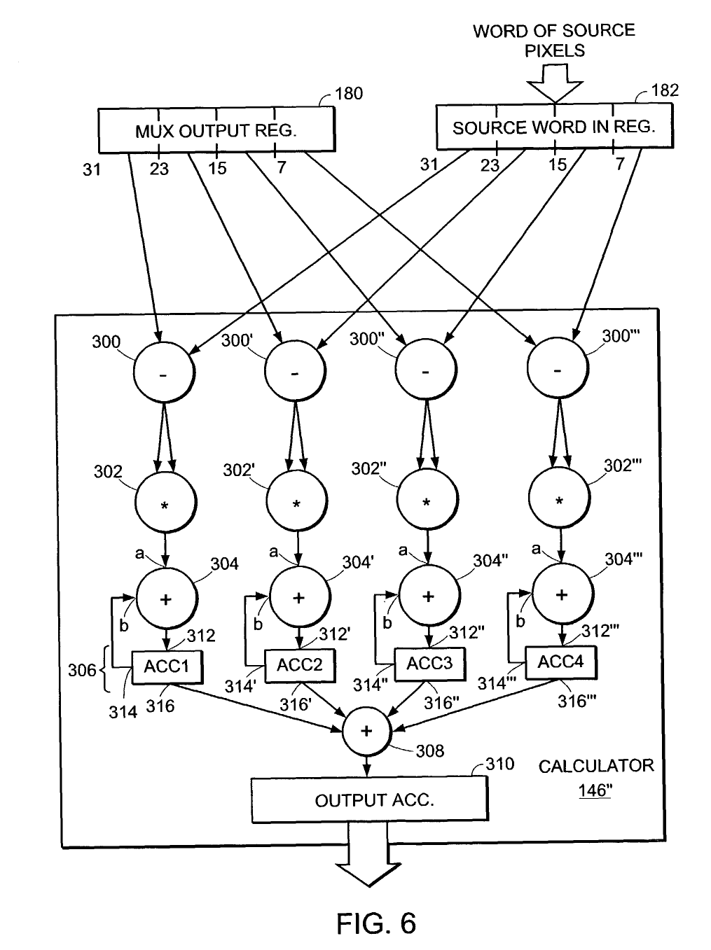

FIG. 6 is a block diagram of another embodiment of a calculator 146′ of the Designer-Designed Computational Unit (DDCU) 112 illustrated in FIG. 2. The calculator 146″ is in electrical communication with the memory buffer 140 of FIG. 4A. In brief overview, the calculator 146″ receives four bytes of predictor pixels and four bytes of source pixels from the memory buffer 140 and simultaneously calculates the sum of squared error (SSE) between the four predictor pixels and four source pixels within a single clock cycle.

The calculator 146″ includes a plurality of subtraction units 300, 300′, 300″, 300′″ (generally, subtraction unit 300), a plurality of multiplication units 302, 302′, 302″, 302′″ (generally, multiplication unit 302), a plurality of adders 304, 304′, 304″, 304′″, a plurality of accumulators 306 (labeled ACC1, ACC2, ACC3, and ACC4), a summing circuit 308, and a SSE output accumulator 310. The accumulators 306 include inputs 312, 312′, 312″, and 312′″ (generally, input 312); first outputs 314, 314′, 314″, and 314′″ (generally, first output 314); and second outputs 316, 316′, 316″, and 316′″ (generally, second output 316). For each pair of bytes being compared to each other, there is one subtraction unit 300, one multiplication unit 302, one adder 304, and one accumulator 306.

Each subtraction unit 300 includes two inputs: a first input that is in communication with one byte of the mux output register 180 and a second input is in communication with one byte of the source word input register 182. Each subtraction unit 300 also includes one output that is in electrical communication with a respective one of the plurality of multiplication units 302. Each multiplication unit 302 includes two inputs that are electrically connected to the output of the respective subtraction unit 300.

Each adder 304 includes two inputs (labeled “a” and “b”) and an output. The input “a” of a respective one of the adder 304 is electrically connected to the output of the respective multiplication unit 302. The input “b” of a respective one of the adder 304 is electrically connected to the first output 314 of the respective accumulator 306.

Each accumulator 306 includes one input 312 that is electrically connected to the output of the respective adder 304. The first output 314 of each accumulator 306 is electrically connected to the input “b” of the respective adder 304 and the second output 316 is electrically connected to the summing circuit 308. The summing circuit 308 includes an input for each accumulator 306 and an output that is electrically connected to the SSE output accumulator 310.

In operation, during a first clock cycle, the memory buffer 140 (FIG. 4A) receives a word of predictor pixels and a word of source pixels from the data communication module (FIG. 1). The memory buffer 140 produces a word of valid predictor pixels and places this word in the mux output register 180, as described in connection with FIG. 4A. The source word input register 182 stores the word of source pixels.

In a second clock cycle, the calculator 146″ receives a word of predictor pixels from the mux output register 180 on input 152 and a word of source pixels from the source word input register on input 150. Each subtraction unit 300 receives one unsigned byte of predictor pixel data from the mux output register 180 and one unsigned byte of source pixel data from the source word input register 182. In one embodiment, each subtraction unit 300 subtracts the source pixel value from the predictor pixel value and produces a nine-bit signed value having the range of values from −255 to 255. This subtraction result passes to both inputs of the respective multiplication unit 302.

Each multiplication unit 302 multiplies the subtraction results received on the two inputs, to square the difference between the predictor pixels and the source pixels. The resulting squared value passes to the input “a” of the respective adder 304. Each adder 304 adds the squared value received on the input “a” with the current value in the respective accumulator 306. The result of the addition operation is stored in the respective accumulator 306.

Accordingly, during the second clock cycle, the calculator 146″ simultaneously calculates the following equations:

ACC1+=(a₄ᵢ−b₄ᵢ)²;

ACC2+=(a₄ᵢ₊₁−b₄ᵢ₊₁)²;

ACC3+=(a₄ᵢ₊₂−b₄ᵢ₊₂)²;

ACC4+=(a₄ᵢ₊₃−b₄ᵢ₊₃)²;

where “ACC” identifies the accumulator 306 in which the results of the respective calculation is stored, “i” is an integer ranging from 0 to 3, “a” is a byte of predictor pixels, and “b” is a byte of source pixels.

The calculator 146″ also calculates these equations for each subsequent clock cycle, until the DDCU 112 has compared a full block of predictor pixels with a full block of source pixels. After the full predictor pixel block is complete, during a subsequent cycle, the summing circuitry 308 adds together the values stored in the accumulators 306 and stores the total in the SSE output accumulator 310.

Equivalents

While the invention has been particularly shown and described with reference to specific preferred embodiments, it should be understood by those skilled in the art that various changes in form and detail can be made therein without departing from the spirit and scope of the invention as defined by the appended claims.

What is claimed is:

1. A method for accelerating calculation of a motion estimation metric, the method comprising:
during a single clock cycle,
providing a first and a second word of packed unsigned bytes, each byte in the first word of packed unsigned bytes representing a pixel in an image to be encoded and each byte in the second word of packed unsigned bytes representing a pixel in a previously encoded image;
pairing each byte in the second word of packed unsigned bytes with one of the bytes in the first word of packed unsigned bytes to generate a plurality of pairs of bytes; and
calculating an error measure for each pair of bytes in the plurality of pairs of bytes to compute a portion of the motion estimation metric for a plurality of pixels during the single clock cycle.

2. The method of claim 1 further comprising receiving a third and a fourth word of packed unsigned bytes, and selecting at least one byte of the third word of packed unsigned bytes and a sufficient number of bytes of the fourth word of packed unsigned bytes to produce the second word of packed unsigned bytes.

3. The method of claim 1 wherein the calculating the error measure includes calculating an absolute difference for each pair of bytes.

4. The method of claim 3 further comprising summing the calculated absolute differences.

5. The method of claim 1 wherein the step of calculating the error measure comprises calculating a squared error for each pair of bytes and summing the calculated squared errors.

6. The method of claim 1 further comprising selecting a type of the error measure that is calculated.

7. The method of claim 6 wherein the type of selected error measure comprises the sum of absolute differences.

8. A method for accelerating calculation of a motion estimation metric, the method comprising:
reading a first and a second word, each of the first and the second word having a plurality of bytes that represent pixels associated with a previously encoded image;
selecting at least one byte of the first word and combining each of the selected bytes with as many bytes of the second word as are needed to complete a word of predictor pixels; and
calculating an error measure for each byte in the word of predictor pixels and a corresponding byte in a word of pixels associated with an image to be encoded.

9. The method of claim 8 wherein the method is performed within a single clock cycle.

10. The method of claim 8 further comprising storing data in the first and the second words in a packed unsigned byte format.

11. The method of claim 8 wherein the selecting at least one byte of the first word comprises determining which of the bytes of the first word to select based on a pixel offset value.

12. The method of claim 8 wherein the calculating the error measure comprises calculating an absolute difference for each byte in the word of predictor pixels and the corresponding byte in the word of pixels associated with the image to be encoded.

13. The method of claim 12 further comprising summing the calculated absolute differences.

14. The method of claim 8 wherein the calculating the error measure comprises calculating a squared error for each byte in the word of predictor pixels and the corresponding byte in the word of pixels associated with the image to be encoded and summing the calculated squared errors.

15. The method of claim 8 further comprising selecting a type of the error measure that is calculated.

16. The method of claim 15 wherein the selecting the type of error measure comprises selecting the sum of absolute differences error measure.

17. A processor for accelerating calculation of a motion estimation metric, the processor comprising:
a first and a second register, the first and the second registers being adapted to store a word of packed unsigned bytes, each byte of the word stored in the first register representing a pixel in an image to be encoded and each byte of the word stored in the second register representing a pixel in a previously encoded image, each byte of the word stored in the first register being paired with one of the bytes of the word stored in the second register; and
a calculator that is in communication with the first and the second registers, the calculator calculating an error measure for each pair of bytes to compute a portion of the motion estimation metric for a plurality of pixels during a single clock cycle.

18. The system of claim 17 further comprising a multiplexer that is in communication with the first and the second registers, the multiplexer selecting at least one byte of predictor pixels from the first word and as many bytes of predictor pixels from the second word as are needed to produce a full word of predictor pixels when the selected bytes are combined.

19. The processor of claim 17 wherein the error measure calculated by the calculator comprises an absolute difference for each pair of bytes.

20. The processor of claim 17 wherein the error measure calculated by the calculator comprises a squared error for each pair of bytes.

21. The processor of claim 17 further comprising a means for selecting a type of the error measure that is calculated.

22. A processor comprising:
a control unit;
a first calculator that is in communication with the control unit, the first calculator calculating a sum of absolute differences between a plurality of predictor pixels and a plurality of source pixels;
a second calculator that is in communication with the control unit, the second calculator calculating a sum of squared error between the plurality of predictor pixels and the plurality of source pixels; and
an instruction set that includes an instruction that directs the control unit to select one of the first and the second calculators when calculating a error measure during video encoding.

23. The processor of claim 22 wherein the first and the second calculators comprise a computational unit that is in communication with the control unit.

24. The processor of claim 22 wherein the first calculator comprises a first computational unit and the second calculator comprises a second computational unit.
